(19) United States
(12) Patent Application Publication
(10) Pub. No.: US 2025/0251307 A1
(43) Pub. Date: Aug. 7, 2025

(54) SYSTEM AND METHOD FOR DETECTING CYCLE JUNCTION POINT IN ROTATING MACHINE

(71) Applicant: HARBOR TECHNOLOGY SOLUTIONS CO., LTD., Taipei City (TW)

(72) Inventor: Hung-Yi Lu, Taipei City (TW)

(21) Appl. No.: 19/033,743

(22) Filed: Jan. 22, 2025

Related U.S. Application Data
(60) Provisional application No. 63/548,896, filed on Feb. 2, 2024.

(51) Int. Cl. G01M 13/028; G01H 1/00

(52) U.S. Cl. CPC G01M 13/028; G01H 1/003

(57) ABSTRACT

A system and a method for detecting a cyclic positioning point in a rotating machine are provided. The system includes: a sensing module configured for obtaining vibration data of an accessory of the rotating machine; a data processing module configured for processing the vibration data to generate vibration time series data; a turn number calculation module configured for calculating the vibration time series data to obtain a number of cutting turns corresponding to the vibration time series data; a module number calculation module configured for calculating the vibration time series data according to the number of cutting turns to obtain a number of modules corresponding to the accessory; and a positioning point calculation module configured for performing calculation according to the number of modules and the vibration time series data to obtain the cyclic positioning point of the accessory.

### BACKGROUND

### 1. Technical Field

The present disclosure relates to a system for detecting a cyclic positioning point and a method thereof, and more particularly, to a system for detecting a cyclic positioning point in a rotating machine and a method thereof.

### 2. Description of Related Art

After a certain period of operation, accessories (e.g., gears, chains/belts, saw belts, drill bits, tires) used in a rotating machine (e.g., a power transmission equipment, a conveyor belt equipment, an electric saw equipment, an electric drill equipment, a transportation equipment) often become damaged, thereby affecting the overall operation of the rotating machine. Therefore, it is necessary to develop relevant technologies for detecting damage to accessories.

In the existing electric saw equipment, the saw belt is usually formed into a loop by welding. However, the existing technology fails to provide a method to effectively locate a welding position, and the welding position must be found manually by visual inspection. Therefore, there are many inconveniences for users, and further subsequent applications are impossible.

### SUMMARY

The present disclosure provides a system for detecting a cyclic positioning point in a rotating machine, the system comprises: a sensing module configured for obtaining vibration data of an accessory of the rotating machine; a data processing module configured for processing the vibration data to generate vibration time series data; a turn number calculation module configured for calculating the vibration time series data to obtain a number of cutting turns corresponding to the vibration time series data; a module number calculation module configured for calculating the vibration time series data according to the number of cutting turns to obtain a number of modules corresponding to the accessory; and a positioning point calculation module configured for performing calculation according to the number of modules and the vibration time series data to obtain the cyclic positioning point of the accessory.

The present disclosure further provides a method for detecting a cyclic positioning point in a rotating machine, the method comprises: obtaining, by a sensing module, vibration data of an accessory of the rotating machine; processing, by a data processing module, the vibration data to generate vibration time series data; calculating, by a turn number calculation module, the vibration time series data to obtain a number of cutting turns corresponding to the vibration time series data; calculating, by a module number calculation module, the vibration time series data according to the number of cutting turns to obtain a number of modules corresponding to the accessory; and performing, by a positioning point calculation module, calculation according to the number of modules and the vibration time series data to obtain the cyclic positioning point of the accessory.

In the above-mentioned system and method for detecting the cyclic positioning point in the rotating machine, wherein the vibration time series data includes a plurality of time points and corresponding plurality of vibration amount, wherein the turn number calculation module first calculates a standard deviation of the plurality of vibration amount, and then divides each of the plurality of vibration amount by the standard deviation and then squares the result, so as to obtain a plurality of first signal-to-noise ratio values and obtain the number of cutting turns according to the plurality of first signal-to-noise ratio values.

In the above-mentioned system and method for detecting the cyclic positioning point in the rotating machine, wherein the turn number calculation module first divides the plurality of first signal-to-noise ratio values into groups of N having the same time interval, the plurality of first signal-to-noise ratio values corresponding to the same time point in each of the groups of N are summed up and divided by N to obtain a maximum value and a minimum value corresponding to N, and the calculation is repeated in an N-increasing manner to obtain a plurality of maximum values and a plurality of minimum values corresponding to a plurality of N, wherein N is a natural number.

In the above-mentioned system and method for detecting the cyclic positioning point in the rotating machine, wherein N corresponding to a greatest difference between the plurality of maximum values and the plurality of minimum values is used as the number of cutting turns.

In the above-mentioned system and method for detecting the cyclic positioning point in the rotating machine, wherein the module number calculation module divides the plurality of first signal-to-noise ratio values into groups of M having the same time interval, the plurality of first signal-to-noise ratio values corresponding to the same time point in each of the groups of M are summed up and divided by M to obtain time series data including a plurality of second signal-to-noise ratio values, wherein M equals to the number of cutting turns.

In the above-mentioned system and method for detecting the cyclic positioning point in the rotating machine, wherein the module number calculation module first divides the plurality of second signal-to-noise ratio values into groups of O having the same time interval, the plurality of second signal-to-noise ratio values corresponding to the same time point in each of the groups of O are summed up and divided by O to obtain a maximum value and a minimum value corresponding to O, and the calculation is repeated in an O-increasing manner to obtain a plurality of maximum values and a plurality of minimum values corresponding to a plurality of O, wherein O is a natural number.

In the above-mentioned system and method for detecting the cyclic positioning point in the rotating machine, wherein O corresponding to a greatest difference between the plurality of maximum values and the plurality of minimum values is used as the number of modules.

In the above-mentioned system and method for detecting the cyclic positioning point in the rotating machine, wherein the positioning point calculation module divides the plurality of second signal-to-noise ratio values into groups of P having the same time interval, the plurality of second signal-to-noise ratio values corresponding to the same time point in each of the groups of P are summed up and divided by P to obtain time series data including a plurality of third signal-to-noise ratio values, wherein P is the number of modules.

In the above-mentioned system and method for detecting the cyclic positioning point in the rotating machine, wherein the positioning point calculation module converts the plurality of third signal-to-noise ratio values into a matrix having m rows and n columns, and calculates a sum of the plurality of third signal-to-noise ratio values of each n columns to obtain a difference between a maximum value and a minimum value in each n columns, wherein m is the number of modules and n is a time point.

In the above-mentioned system and method for detecting the cyclic positioning point in the rotating machine, wherein the positioning point calculation module sequentially shifts positions of the plurality of third signal-to-noise ratio values in the matrix to repeatedly calculate and obtain a plurality of differences, and performs calculation according to shifting times corresponding to a greatest one of the plurality of differences to obtain the cyclic positioning point.

In the above-mentioned system and method for detecting the cyclic positioning point in the rotating machine, wherein the shift is to move the plurality of third signal-to-noise ratio values from the mth row and the nth column to the mth row and the n+1th column, the m+1th row and the 1st column, or the 1st row and the 1st column, respectively.

In the above-mentioned system and method for detecting the cyclic positioning point in the rotating machine, wherein the data processing module first calculates a standard deviation of the vibration data, and defines a portion of the vibration data that is greater than the standard deviation as an operation interval, and defines a portion of the vibration data that is less than the standard deviation as a standby interval, wherein the vibration data corresponding to the operation interval between the two adjacent standby intervals is the vibration time series data.

In the above-mentioned system and method for detecting the cyclic positioning point in the rotating machine, wherein the vibration data is mechanical motion vibration data or sound vibration data.

In summary, the system and the method for detecting a cyclic positioning point in a rotating machine according to the present disclosure can effectively locate a welding position of a saw belt without the need for manual visual search. Furthermore, the welding position found by computer automatic calculation in the present disclosure can be further used in subsequent applications, such as calculating a distance between the abnormal saw tooth and the welding position.

### BRIEF DESCRIPTION OF THE DRAWINGS

FIG. 1 is a system architecture diagram of a system for detecting a cyclic positioning point in a rotating machine according to the present disclosure.

FIG. 2 is a flowchart illustrating a method for detecting a cyclic positioning point in a rotating machine according to the present disclosure.

FIG. 3 is a diagram of vibration data according to the present disclosure.

FIG. 4 is a diagram of vibration time series data according to the present disclosure.

FIG. 5 is a diagram showing a curve of a number of turns tried and first signal-to-noise ratio values according to the present disclosure.

FIG. 6 is a diagram showing a curve of a number of modules tried and second signal-to-noise ratio values according to the present disclosure.

FIG. 7 and FIG. 8 are respectively phase diagrams of the present disclosure that visualize the number of modules, third signal-to-noise ratio values, and a time point.

### DETAILED DESCRIPTION

The following illustrative embodiments are provided to illustrate the present disclosure, these and other advantages and effects can be apparently understood by those in the art after reading the disclosure of this specification. However, the present disclosure can also be implemented or applied through other different specific implementation forms.

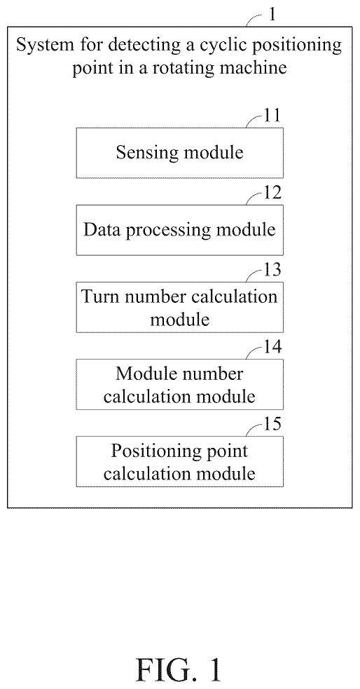

FIG. 1 is a system architecture diagram of a system 1 for detecting a cyclic positioning point in a rotating machine according to the present disclosure. The system 1 for detecting the cyclic positioning point in the rotating machine comprises a sensing module 11, a data processing module 12, a turn number calculation module 13, a module number calculation module 14 and a positioning point calculation module 15.

In one embodiment, the system 1 for detecting the cyclic positioning point in the rotating machine can be run in a computer device having a processing unit and a storage unit. The processing unit may be a central processing unit (CPU), a microprocessor, a graphics processing unit (GPU), or an application specific integrated circuit (ASIC). The storage unit may be any type of fixed or removable random access memory (RAM), read-only memory (ROM), flash memory, hard disk, soft disk, database, or a combination of the above elements. The computer device can be a mobile phone, a tablet computer, a laptop computer, a desktop computer, a server, or a cloud server.

The data processing module 12, the turn number calculation module 13, the module number calculation module 14 and the positioning point calculation module 15 can be respectively program code segments, software, or firmware stored in the storage unit and can be executed by the processing unit, but the present disclosure is not limited to as such. The data processing module 12, the turn number calculation module 13, the module number calculation module 14 and the positioning point calculation module 15 may also be implemented by using other hardware or a combination of hardware and software.

The sensing module 11 is configured for obtaining vibration data of the accessories of the rotating machine. In one embodiment, the sensing module 11 is specifically a sensor made of piezoelectric material (crystal or ceramic), or a general vibration sensor, but the present disclosure is not limited to as such. When the sensing module 11 is a sensor made of piezoelectric material, the vibration data is sound vibration data, and when the sensing module 11 is a general vibration sensor, the vibration data is mechanical motion vibration data.

In one embodiment, the rotating machine may be, for example, an electric saw equipment having a saw bed, and the corresponding accessory is a saw belt. In other embodiments, the rotating machine may also be, for example, a power transmission equipment, a conveyor belt equipment, an electric drill equipment, and a transportation equipment. The corresponding accessories are gears, chains/belts, drill bits, and tires, but the present disclosure is not limited to as such.

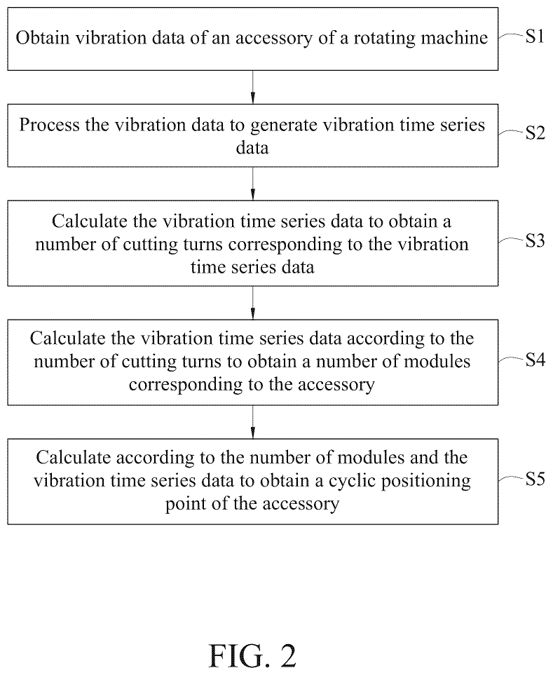

Please refer to FIG. 2. A method for detecting a cyclic positioning point in a rotating machine according to the present disclosure can be executed by the system 1 for detecting the cyclic positioning point in the rotating machine described above, wherein the method comprises: in step S1, obtaining vibration data of an accessory of a rotating machine; in step S2, processing the vibration data to generate vibration time series data; in step S3, calculating the vibration time series data to obtain a number of cutting turns corresponding to the vibration time series data; in step S4, calculating the vibration time series data according to the number of cutting turns to obtain a number of modules corresponding to the accessory; and in step S5, calculating according to the number of modules and the vibration time series data to obtain a cyclic positioning point of the accessory.

The following further describes the detailed operation of the system 1 for detecting the cyclic positioning point in the rotating machine in sequence according to the sequence of the method for detecting the cyclic positioning point in the rotating machine. The technical contents of the above method for detecting the cyclic positioning point in the rotating machine that are the same as those of the system 1 for detecting the cyclic positioning point in the rotating machine will not be repeated here.

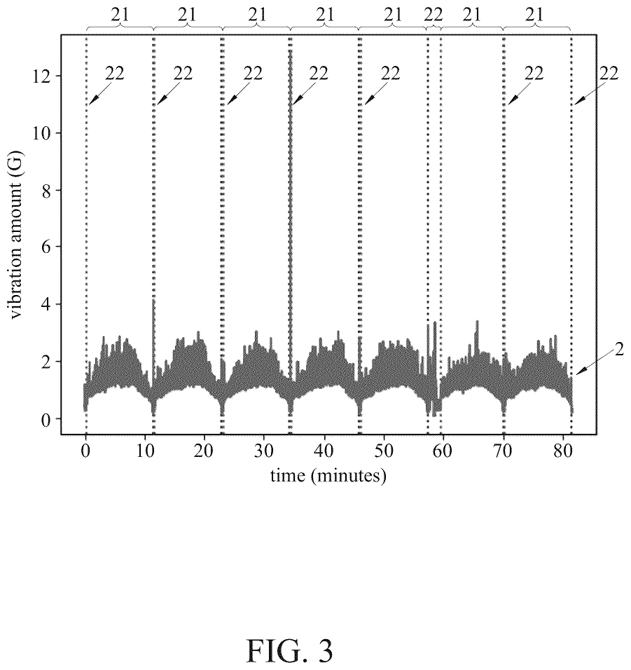

FIG. 3 is a diagram of vibration data 2 of an accessory in a rotating machine obtained by the sensing module 11. In one embodiment, the sensing module 11 can connect each vibration data with a recording time length of 5 seconds from beginning to end to form a continuous and complete vibration data 2, as shown in FIG. 3, wherein the X-axis represents time (minutes), and the Y-axis represents vibration amount (G).

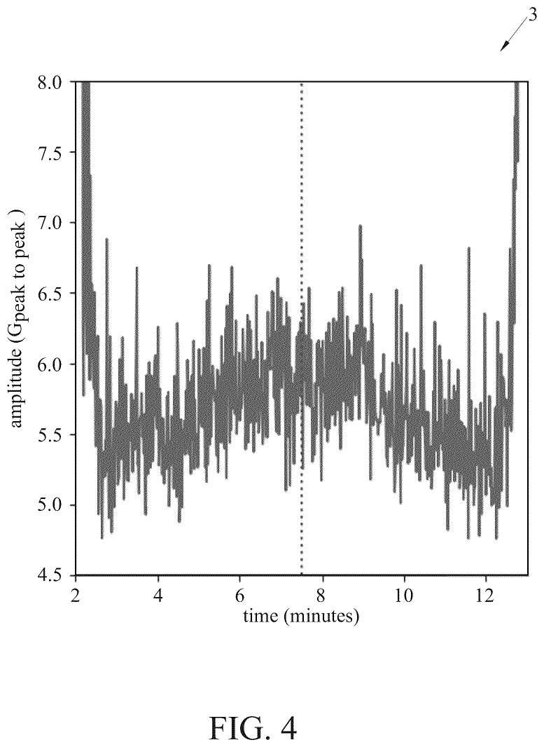

The data processing module 12 is used to process the vibration data 2 to generate vibration time series data. In one embodiment, the data processing module 12 first calculates a standard deviation of the vibration data 2, defines a portion of the vibration data 2 that is greater than the standard deviation as an operation interval 21, and defines a portion of the vibration data 2 that is less than the standard deviation as a standby interval 22. In this way, an operation starting point and an operation ending point can be distinguished according to the operation interval 21 and the standby interval 22. For example, the leftmost standby interval 22 in FIG. 3 can be regarded as an operation starting point, the second standby interval 22 on the left in FIG. 3 can be regarded as an operation ending point, and a vibration data of an operation interval 21 between the two standby intervals 22 can be used as a vibration time series data. That is, the vibration data 2 shown in FIG. 3 can generate 7 vibration time series data (for example, it can represent that a saw belt is used in an electric saw equipment with a saw bed to perform 7 cutting operations), and it can be expressed as vibration time series data 3 as shown in FIG. 4 when the X-axis unit of each vibration time series data is expressed in minutes and the Y-axis unit of each vibration time series data is converted from the vibration amount (G) to the amplitude (G)_{peak to peak}.

In one embodiment, all vibration data 2 within an operation interval 21 can be used as vibration time series data 3. However, the vibration data 2 within a certain period of time before and after a midpoint of the operation interval 21 (e.g., 5 minutes before and after) can also be used as the vibration time series data 3, and the present disclosure is not limited to as such.

The turn number calculation module 13 calculates a vibration time series data 3 representing a cutting operation, and can obtain the number of cutting turns (also known as the number of rotation revolutions of the accessory of the rotating machine) corresponding to the vibration time series data 3 in the cutting operation.

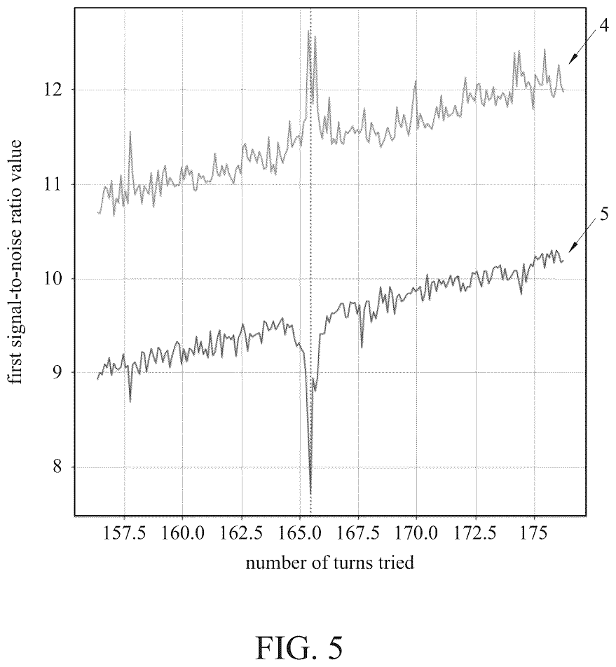

Specifically, as shown in FIG. 4, the vibration time series data 3 includes a plurality of time points and corresponding plurality of vibration amount, wherein the turn number calculation module 13 first calculates a standard deviation of the plurality of vibration amount, and then divides each vibration amount by the standard deviation and then squares the result, so as to obtain a plurality of first signal-to-noise ratio values corresponding to each time point. Next, the turn number calculation module 13 assumes a number of turns tried corresponding to the plurality of first signal-to-noise ratio values to obtain the maximum value and the minimum value of the corresponding number of turns tried. For example, when the number of turns tried is 1, the maximum value and the minimum value are directly obtained from the plurality of first signal-to-noise ratio values. For example, when the number of turns tried is 2, the turn number calculation module 13 first divides the plurality of first signal-to-noise ratio values into groups of two having the same time interval, and the plurality of first signal-to-noise ratio values corresponding to the same time point in each of the groups of two are summed up and then divided by 2 to obtain the maximum value and the minimum value of the corresponding groups of two. That is, when the number of turns tried is N, the turn number calculation module 13 first divides the plurality of first signal-to-noise ratio values into groups of N having the same time interval, and the plurality of first signal-to-noise ratio values corresponding to the same time point in each of the groups of N are summed up and then divided by N to obtain the maximum value and the minimum value of the corresponding groups of N, wherein N is a natural number. The turn number calculation module 13 can repeat the calculation in an N-increasing manner, for example, N=1 to 200, so that 200 groups of maximum values and minimum values can be obtained. From the 200 groups of maximum values and minimum values, a group with the greatest difference between the maximum value and the minimum value is obtained, and the number of turns tried corresponding to the group is used as the number of cutting turns. If the number of turns tried is used as the X-axis and the first signal-to-noise ratio value is used as the Y-axis, a maximum value curve 4 and a minimum value curve 5 as shown in FIG. 5 can be plotted. As can be seen from FIG. 5, when the number of turns tried N=165.5, the difference between the maximum value and the minimum value corresponding to the N is the greatest, so the number of cutting turns can be set to 165.5 turns.

The above embodiment starts with N=1, but the present disclosure is not limited to as such. A range may also be set for calculation, such as calculation from N=156 to N=176 as shown in FIG. 5. Furthermore, N can be a positive integer, and can also include an integer part and a decimal part.

After obtaining the number of cutting turns, the module number calculation module 14 can calculate the vibration time series data 3 according to the number of cutting turns to obtain the number of modules corresponding to the accessory of the rotating machine. The number of modules referred to herein may be the number of saw teeth on the saw belt, that is, one module corresponds to one saw tooth, and the distances between the saw teeth are unevenly distributed, but the present disclosure is not limited to as such, and a plurality of saw teeth may correspond to one module.

Specifically, assuming that the number of cutting turns is groups of M, the module number calculation module 14 divides the plurality of first signal-to-noise ratio values into groups of M having the same time interval, and the plurality of first signal-to-noise ratio values corresponding to the same time point in each of the groups of M are summed up and divided by M to obtain time series data including a plurality of second signal-to-noise ratio values, wherein M is a natural number.

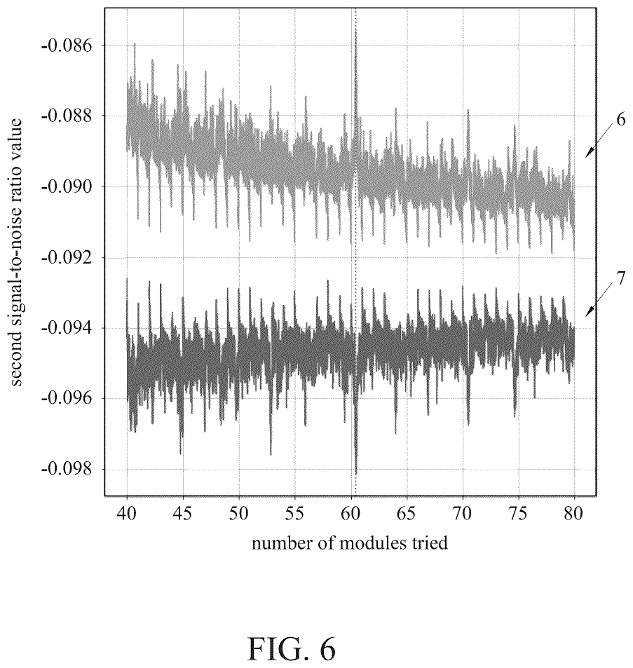

Next, the module number calculation module 14 assumes a number of modules tried corresponding to a plurality of second signal-to-noise ratio values to obtain the maximum value and the minimum value of the corresponding number of modules tried. For example, when the number of modules tried is 1, the maximum value and the minimum value are directly obtained from the plurality of second signal-to-noise ratio values. For example, when the number of modules tried is 2, the module number calculation module 14 first divides the plurality of second signal-to-noise ratio values into groups of two having the same time interval, and the plurality of second signal-to-noise ratio values corresponding to the same time point in each of the groups of two are summed up and then divided by 2 to obtain the maximum value and the minimum value of the corresponding groups of two. That is, when the number of modules tried is O, the module number calculation module 14 first divides the plurality of second signal-to-noise ratio values into groups of O having the same time interval, and the plurality of second signal-to-noise ratio values corresponding to the same time point in each of the groups of O are summed up and then divided by O to obtain the maximum value and the minimum value of the corresponding groups of O, wherein O is a natural number. The module number calculation module 14 can repeat the calculation in an O-increasing manner, for example, O=1 to 100, so that 100 groups of maximum values and minimum values can be obtained. From the 100 groups of maximum values and minimum values, a group with the greatest difference between the maximum value and the minimum value is obtained, and the number of modules tried corresponding to the group is used as the number of modules. If the number of modules tried is used as the X-axis and the second signal-to-noise ratio value is used as the Y-axis, a maximum value curve 6 and a minimum value curve 7 as shown in FIG. 6 can be plotted. As can be seen from FIG. 6, when the number of modules tried O=60.4, the difference between the maximum value and the minimum value corresponding to the O is the greatest, so the number of modules can be set to 60.4 groups.

The above embodiment starts with O=1, but the present disclosure is not limited to as such. A range may also be set for calculation, such as calculation from O=40 to O=80 as shown in FIG. 6. Furthermore, O can be a positive integer, and can also include an integer part and a decimal part.

After obtaining a number of modules corresponding to the accessory, the positioning point calculation module 15 can perform calculations based on the number of modules and the vibration time series data 3 to obtain a cyclic positioning point of the accessory, that is, a welding position of the saw belt.

Specifically, the positioning point calculation module 15 can divide the plurality of second signal-to-noise ratio values into groups of P having the same time interval according to the number of modules, and the plurality of second signal-to-noise ratio values corresponding to the same time point in each group are summed up and then divided by P to obtain time series data including a plurality of third signal-to-noise ratio values, wherein P is the module number.

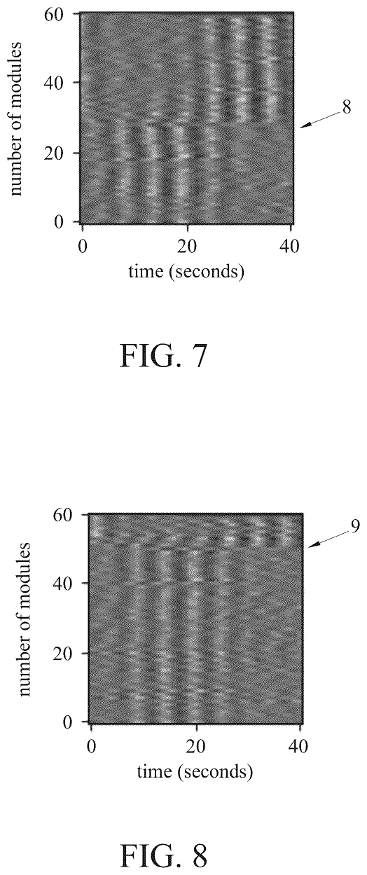

Next, the positioning point calculation module 15 converts the plurality of third signal-to-noise ratio values into a matrix having m rows and n columns, wherein m is the number of modules and n is the time point (second). If the matrix is visualized, a phase diagram as shown in FIG. 7 or FIG. 8 may be presented. Next, the positioning point calculation module 15 shifts the positions of the third signal-to-noise ratio values in the matrix to repeatedly calculate and obtain a plurality of differences, and performs calculation according to shifting times corresponding to the greatest one of the plurality of differences to obtain a cyclic positioning point.

Taking the 3×3 matrix

$$[ \begin{matrix}a & b & c \\ d & e & f \\ g & h & i\end{matrix} ]$$

as an example, a specific method of shifting the third signal-to-noise ratio values is explained, wherein a to i are the third signal-to-noise ratio values. First, the sum of the third signal-to-noise ratio values of each column is calculated. A1=a+d+g for the first column, A2=b+e+h for the second column, and A3=c+f+i for the third column can be obtained, and a difference between the maximum value and the minimum value from A1 to A3 can be obtained.

Next, i is moved from the 3rd row and the 3rd column to the 1st row and the 1st column, and the other numbers are moved in sequence, and a 3×3 matrix

$$[ \begin{matrix}i & a & b \\ c & d & e \\ f & g & h\end{matrix} ]$$

can be obtained. For example, a moves from row 1 and column 1 to row 1 and column 2, b moves from row 1 and column 2 to row 1 and column 3, c moves from row 1 and column 3 to row 2 and column 1, and so on. Next, the sum of the third signal-to-noise ratio values of each column is calculated. A1=i+c+f for the first column, A2=a+d+g for the second column, and A3=b+e+h for the third column can be obtained, and a difference between the maximum value and the minimum value from A1 to A3 can be obtained. The next round is to move h from the 3rd row and the 3rd column to the 1st row and the 1st column, and the other numbers will be moved in sequence, and so on, so as to get a difference between the maximum value and the minimum value of this round. A total of 9 groups of differences can be obtained from the 3×3 matrix. By obtaining the maximum difference from the 9 groups of differences, a cyclic positioning point can be calculated.

Taking FIG. 7 and FIG. 8 as an example, since the length of the saw belt is fixed, the welding position will cause the saw teeth to be arranged discontinuously, resulting in phase misalignment. The cyclic positioning point 8 in FIG. 7 is located at the 27th module group, that is, the position of the module number=27, and it can be seen that the phases above and below it are discontinuous. The cyclic positioning point 9 in FIG. 8 is located at the 51st module group, that is, the position of the module number=51, and it can be seen that the phases above and below it are discontinuous. If the cyclic positioning point in FIG. 7 or FIG. 8 is located at the 60th module, it can be seen that the phase discontinuity disappears. At this time, in the sum of the third signal-to-noise ratio values of each column of the matrix, the difference between the maximum value and the minimum value is the greatest. According to the above matrix shift calculation method, for example, in FIG. 7, after 33 shifts, a difference between the maximum value and the minimum value in the sum of the third signal-to-noise ratio values of each column of the matrix being the greatest can be obtained, that is, the 60th module is reached. As long as 33 modules are shifted back, it should be known that the cyclic positioning point 8 is in the 27th module. For another example, in FIG. 8, after 9 shifts, a difference between the maximum value and the minimum value in the sum of the third signal-to-noise ratio values of each column of the matrix being the greatest can be obtained, that is, the 60th module is reached. As long as 9 modules are shifted back, it should be known that the cyclic positioning point 9 is in the 51st module.

In summary, the system and the method for detecting a cyclic positioning point in a rotating machine according to the present disclosure can effectively locate a welding position of a saw belt without the need for manual visual search. Furthermore, the welding position found by computer automatic calculation in the present disclosure can be further used in subsequent applications, such as calculating a distance between the abnormal saw tooth and the welding position.

The foregoing embodiments are provided for the purpose of illustrating the principles, features and effects of the present disclosure, rather than limiting the present disclosure. Anyone skilled in the art can modify and alter the above embodiments without departing from the spirit and scope of the present disclosure. Any equivalent implementation or modification that does not depart from the technical spirit of the present disclosure shall be included in the patent scope of the present disclosure. Therefore, the scope of protection with regard to the present disclosure should be as defined in the accompanying claims listed below.

What is claimed is:

1. A system for detecting a cyclic positioning point in a rotating machine, comprising:
a sensing module configured for obtaining vibration data of an accessory of the rotating machine;
a data processing module configured for processing the vibration data to generate vibration time series data;
a turn number calculation module configured for calculating the vibration time series data to obtain a number of cutting turns corresponding to the vibration time series data;
a module number calculation module configured for calculating the vibration time series data according to the number of cutting turns to obtain a number of modules corresponding to the accessory; and
a positioning point calculation module configured for performing calculation according to the number of modules and the vibration time series data to obtain the cyclic positioning point of the accessory.

2. The system of claim 1, wherein the vibration time series data includes a plurality of time points and corresponding plurality of vibration amount, wherein the turn number calculation module first calculates a standard deviation of the plurality of vibration amount, and then divides each of the plurality of vibration amount by the standard deviation and then squares the result, so as to obtain a plurality of first signal-to-noise ratio values and obtain the number of cutting turns according to the plurality of first signal-to-noise ratio values.

3. The system of claim 2, wherein the turn number calculation module first divides the plurality of first signal-to-noise ratio values into groups of N having the same time interval, the plurality of first signal-to-noise ratio values corresponding to the same time point in each of the groups of N are summed up and divided by N to obtain a maximum value and a minimum value corresponding to N, and the calculation is repeated in an N-increasing manner to obtain a plurality of maximum values and a plurality of minimum values corresponding to a plurality of N, wherein N is a natural number.

4. The system of claim 3, wherein N corresponding to a greatest difference between the plurality of maximum values and the plurality of minimum values is used as the number of cutting turns.

5. The system of claim 2, wherein the module number calculation module divides the plurality of first signal-to-noise ratio values into groups of M having the same time interval, the plurality of first signal-to-noise ratio values corresponding to the same time point in each of the groups of M are summed up and divided by M to obtain time series data including a plurality of second signal-to-noise ratio values, wherein M equals to the number of cutting turns.

6. The system of claim 5, wherein the module number calculation module first divides the plurality of second signal-to-noise ratio values into groups of O having the same time interval, the plurality of second signal-to-noise ratio values corresponding to the same time point in each of the groups of O are summed up and divided by O to obtain a maximum value and a minimum value corresponding to O, and the calculation is repeated in an O-increasing manner to obtain a plurality of maximum values and a plurality of minimum values corresponding to a plurality of O, wherein O is a natural number.

7. The system of claim 6, wherein O corresponding to a greatest difference between the plurality of maximum values and the plurality of minimum values is used as the number of modules.

8. The system of claim 5, wherein the positioning point calculation module divides the plurality of second signal-to-noise ratio values into groups of P having the same time interval, the plurality of second signal-to-noise ratio values corresponding to the same time point in each of the groups of P are summed up and divided by P to obtain time series data including a plurality of third signal-to-noise ratio values, wherein P is the number of modules.

9. The system of claim 8, wherein the positioning point calculation module converts the plurality of third signal-to-noise ratio values into a matrix having m rows and n columns, and calculates a sum of the plurality of third signal-to-noise ratio values of each n columns to obtain a difference between a maximum value and a minimum value in each n columns, wherein m is the number of modules and n is a time point.

10. The system of claim 9, wherein the positioning point calculation module sequentially shifts positions of the plurality of third signal-to-noise ratio values in the matrix to repeatedly calculate and obtain a plurality of differences, and performs calculation according to shifting times corresponding to a greatest one of the plurality of differences to obtain the cyclic positioning point.

11. The system of claim 10, wherein the shift is to move the plurality of third signal-to-noise ratio values from the mth row and the nth column to the mth row and the n+1th column, the m+1th row and the 1st column, or the 1st row and the 1st column, respectively.

12. The system of claim 1, wherein the data processing module first calculates a standard deviation of the vibration data, and defines a portion of the vibration data that is greater than the standard deviation as an operation interval, and defines a portion of the vibration data that is less than the standard deviation as a standby interval, wherein the vibration data corresponding to the operation interval between the two adjacent standby intervals is the vibration time series data.

13. The system of claim 1, wherein the vibration data is mechanical motion vibration data or sound vibration data.

14. A method for detecting a cyclic positioning point in a rotating machine, comprising:
obtaining, by a sensing module, vibration data of an accessory of the rotating machine;
processing, by a data processing module, the vibration data to generate vibration time series data;
calculating, by a turn number calculation module, the vibration time series data to obtain a number of cutting turns corresponding to the vibration time series data;
calculating, by a module number calculation module, the vibration time series data according to the number of cutting turns to obtain a number of modules corresponding to the accessory; and
performing, by a positioning point calculation module, calculation according to the number of modules and the vibration time series data to obtain the cyclic positioning point of the accessory.

15. The method of claim 14, wherein the vibration time series data includes a plurality of time points and corresponding plurality of vibration amount, wherein the turn number calculation module first calculates a standard deviation of the plurality of vibration amount, and then divides each of the plurality of vibration amount by the standard deviation and then squares the result, so as to obtain a plurality of first signal-to-noise ratio values and obtain the number of cutting turns according to the plurality of first signal-to-noise ratio values.

16. The method of claim 15, wherein the turn number calculation module first divides the plurality of first signal-to-noise ratio values into groups of N having the same time interval, the plurality of first signal-to-noise ratio values corresponding to the same time point in each of the groups of N are summed up and divided by N to obtain a maximum value and a minimum value corresponding to N, and the calculation is repeated in an N-increasing manner to obtain a plurality of maximum values and a plurality of minimum values corresponding to a plurality of N, wherein N is a natural number.

17. The method of claim 16, wherein N corresponding to a greatest difference between the plurality of maximum values and the plurality of minimum values is used as the number of cutting turns.

18. The method of claim 15, wherein the module number calculation module divides the plurality of first signal-to-noise ratio values into groups of M having the same time interval, the plurality of first signal-to-noise ratio values corresponding to the same time point in each of the groups of M are summed up and divided by M to obtain time series data including a plurality of second signal-to-noise ratio values, wherein M equals to the number of cutting turns.

19. The method of claim 18, wherein the module number calculation module first divides the plurality of second signal-to-noise ratio values into groups of O having the same time interval, the plurality of second signal-to-noise ratio values corresponding to the same time point in each of the groups of O are summed up and divided by O to obtain a maximum value and a minimum value corresponding to O, and the calculation is repeated in an O-increasing manner to obtain a plurality of maximum values and a plurality of minimum values corresponding to a plurality of O, wherein O is a natural number.

20. The method of claim 19, wherein O corresponding to a greatest difference between the plurality of maximum values and the plurality of minimum values is used as the number of modules.

21. The method of claim 18, wherein the positioning point calculation module divides the plurality of second signal-to-noise ratio values into groups of P having the same time interval, the plurality of second signal-to-noise ratio values corresponding to the same time point in each of the groups of P are summed up and divided by P to obtain time series data including a plurality of third signal-to-noise ratio values, wherein P is the number of modules.

22. The method of claim 21, wherein the positioning point calculation module converts the plurality of third signal-to-noise ratio values into a matrix having m rows and n columns, and calculates a sum of the plurality of third signal-to-noise ratio values of each n columns to obtain a difference between a maximum value and a minimum value in each n columns, wherein m is the number of modules and n is a time point.

23. The method of claim 22, wherein the positioning point calculation module sequentially shifts positions of the plurality of third signal-to-noise ratio values in the matrix to repeatedly calculate and obtain a plurality of differences, and performs calculation according to shifting times corresponding to a greatest one of the plurality of differences to obtain the cyclic positioning point.

24. The method of claim 23, wherein the shift is to move the plurality of third signal-to-noise ratio values from the mth row and the nth column to the mth row and the n+1th column, the m+1th row and the 1st column, or the 1st row and the 1st column, respectively.

25. The method of claim 14, wherein the data processing module first calculates a standard deviation of the vibration data, and defines a portion of the vibration data that is greater than the standard deviation as an operation interval, and defines a portion of the vibration data that is less than the standard deviation as a standby interval, wherein the vibration data corresponding to the operation interval between the two adjacent standby intervals is the vibration time series data.

26. The method of claim 14, wherein the vibration data is mechanical motion vibration data or sound vibration data.
